(19) United States
(12) Patent Application Publication
(10) Pub. No.: US 2007/0116059 A1
(43) Pub. Date: May 24, 2007

(54) Circuit and method for synchronization

(76) Inventor: Imre Hipp, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/582,150

(22) PCT Filed: Nov. 29, 2004
(86) PCT No.: PCT/EP04/53154

§ 371 Date: Jun. 8, 2006

(30) Foreign Application Priority Data
Dec. 9, 2003 (DE) 10357477.8

(51) Int. Cl. H04J 3/06; H04L 12/56

(52) U.S. Cl. 370/503; 370/395.62

(57) ABSTRACT

The invention relates to a circuit and associated method for synchronizing clock pulses, which enables, with a combined pulse spacing coding and pulse width coding, a simultaneous, collision-free, real time transmission of a number of plesiochronous reference clock signals on a bus line between network units, whereby the selection of the redundant reference clock pulses ensues without involving a central control unit that controls the first and second network unit.

### CROSS REFERENCE TO RELATED APPLICATIONS

This application is the US National Stage of International Application No. PCT/EP2004/053154, filed Nov. 29, 2004 and claims the benefit thereof. The International Application claims the benefits of German Patent application No. 10357477.8 filed Dec. 9, 2003. All of the applications are incorporated by reference herein in their entirety.

### FIELD OF THE INVENTION

The present invention relates to an electrical circuit and a method for clock synchronization.

### BACKGROUND OF THE INVENTION

Telecommunication devices, such as Media Gateways typically use interworking devices to connect a packet-oriented data traffic network to a network for which voice and data transmission are based on a Time Division Multiplex TDM. For as long as these networks are to be operated alongside each other and are to be intermeshed with one another, the quality of the voice and/or data transmission between the networks is governed by the synchronicity of the two networks.

FIG. 1 shows a schematic diagram of a network interworking unit NUE. This interworking unit NUE is for example subdivided into a first network unit NTDM for which data transmission is based on Time Division Multiplex operation and a second network unit NP, a packet-oriented network unit, as well as a system control unit SS controlling the relevant firmware of the first and second network units NTDM, NP. The Time Division Multiplex network unit NTDM is subdivided into a plurality of interface units S1, . . . , Sn. An interface unit Sn features devices such as a clock recovery unit CR, a control register KR, a firmware module FWM, a clock selector T and also bus drivers BT. On the input side Primary Digital Carrier signals PDC1, . . . , n are applied to the clock recovery unit CR. 2048 kBit/s and 1544 kBit/s can be used as bit rates for the Primary Digital Carrier signals PDC. FIG. 2 depicts a block diagram of a data, alarm and clock recovery unit FALC which can be employed as a clock recovery unit CR in the interworking unit NUE With this clock recovery unit CR the clock signal featuring a clock frequency is obtained from the Primary Digital Carrier signals PDCn present on the input side by a digital clock recovery module CRM in each case and any link jitter for example is filtered out of the signal by a downstream filter module JA.

Usually the interface unit Sn is embodied so that only one clock signal, which can also be referred to as a reference signal, is selected by the clock recovery unit CR from the data stream. This reference clock signal RCLK is transmitted redundantly in each case via a first bus connection REFBUS, as well as via a second redundant connection to a clock generation unit T featuring a Phase-Locked Loop PLL to a packet hub PHUB in the second unit NP.

The extracted reference clock signal RCLK(n) is pre-selected by the appropriate interface unit S1, . . . , Sn and forwarded by a bus driver BT. The bus driver BT operates in open collector mode in which only the low potential of the digital channel signal is applied to the bus. By contrast with the standardized collision detection bus method, as is employed in the Ethernet, a higher-ranking system control unit SS ensures here that only one bus driver DT is ever active at the same time in the interface units S1, . . . , Sn. The reason for this is the necessity for a real time transmission of the extracted clock or reference clock signals in unrestricted bandwidth.

The packet-oriented network unit NP features the packet hub PHUB, units such as a firmware module FWM and a clock generation unit T embodied with a Phase-Locked Loop unit PLL. The firmware module FWM of the network units NTDM and NP is activated by a system control unit SS of the interworking unit NUE.

A disadvantage of the known interworking unit NUE lies in the great effort involved in adapting the firmware if changes as regards synchronization are to be made in the first or second network unit.

### SUMMARY OF THE INVENTION

The object of the invention is to specify a further circuit and a method for clock synchronization.

The object is achieved by the features of the claims.

The invention provides the advantage of giving greater flexibility for changes to the network concerned or when networks are expanded.

The invention provides the advantage that an independent sending of clock signals from a number of clock recovery units is undertaken on a first connection without the involvement of a central control unit synchronizing the first and second network unit.

The invention provides the advantage of a coordinated pulse distance and pulse width encoding allowing a simultaneous, collision-free real time transmission of a number of plesiochronous clock signals on a common bus signal at the same time without restricting the bandwidth.

The invention provides the advantage that the firmware for activation of the interface unit as well as a synchronization of the interface unit in the first network unit with the second network unit is no longer needed.

The invention provides the advantage that further clock sequences can be selected at a later time without settings or changes to the firmware in the first network unit and bus operation between the first and second network unit does not need to be interrupted in this case.

### BRIEF DESCRIPTION OF THE DRAWINGS

Further special features of the invention can be seen in the explanation for the Figures of an exemplary embodiment with reference to schematic drawings.

The figures show:

FIG. 1 a block diagram for clock synchronization,

FIG. 2 a block diagram of a clock recovery unit,

FIG. 3 a block diagram of a further circuit for clock synchronization,

FIG. 4 pulse diagrams,

FIG. 5 an embodiment of a bus signal PWDC,

FIG. 6 pulse diagrams for forming a safety margin between the clock signals of different channels,

FIG. 7 incorporation of blocking areas,

FIG. 8 block diagram of an N-channel decoder,

FIG. 9 the associated pulse diagram,

FIG. 10 an associated mask layout,

FIG. 11 a pulse distance algorithm for a 3-channel and

FIG. 12 for a 4-channel bus signal.

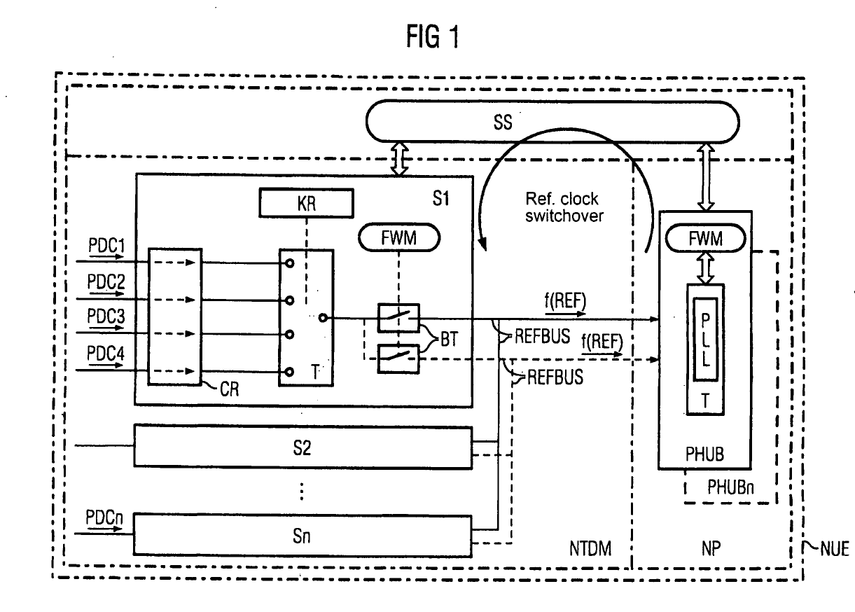

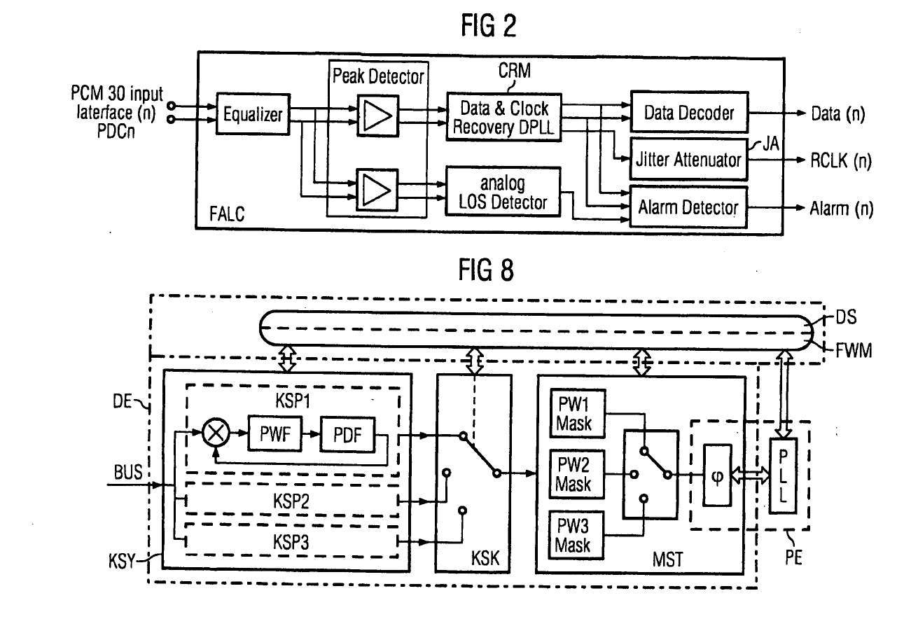

### DETAILED DESCRIPTION OF THE INVENTION

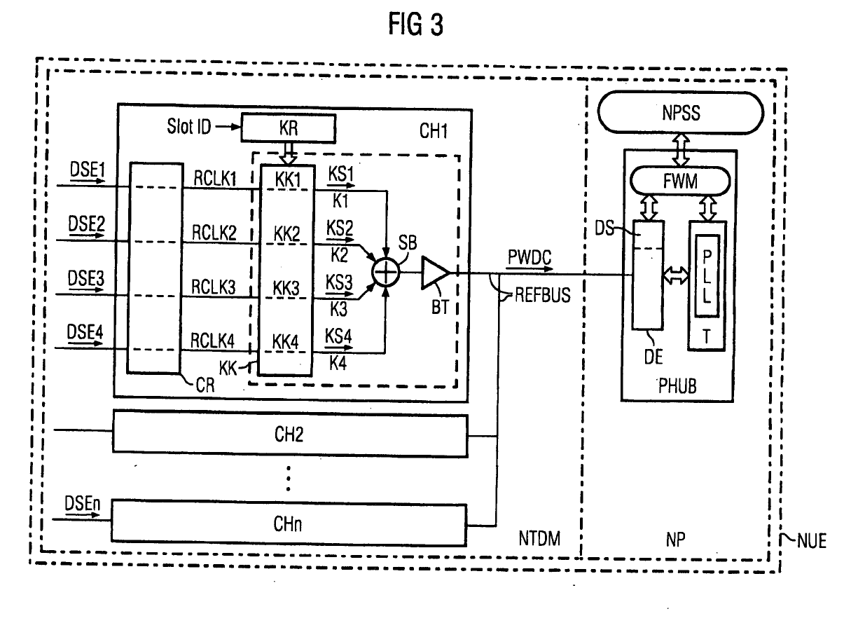

FIG. 3 shows a schematic layout of a circuit for clock synchronization. This circuit of an interworking unit NUE is formed from a first network unit NTDM and a second network unit NP. The first network unit is divided up into one or more bus signal provision units CH1, . . . , CHn. The second network unit NP features a network unit system controller NPSS as well as a packet hub PHUB, with for example firmware FWM, a decoder unit DE with a decoder control unit DS as well as a clock generator unit T typically embodied with a Phase-Locked Loop unit PLL being arranged in the packet hub PHUB. The bus signal provision unit CH1, . . . , CHn can preferably be realized in a HW module and be adapted by configuration to the properties of the network environment by the operator. Redundant circuit units and associated connecting paths are not shown. The corresponding reference clock signals RCLK are recovered in the clock recovery unit CR from the data signals DSE1, . . . , DSEn present on the input side at the bus signal provision units CH1, . . . , CHn and forwarded in each case to a channel encoder KK1, . . . , KK4 which operates separately. These reference clock signals can also be referred to as clock source in each case. In a first step a reference frequency f(REF) is created by frequency division in the channel encoder from the reference clock signal RCLKi present on the input side in each case. In a second step the created reference frequency f(REF) is encoded with the aid of the reference clock signal RCLK into a channel signal KS. Based on a pre-selection which can be set in the configuration register KR, a bus signal PWDC is formed from the individual channel signals KS₁, . . . , KSₙ via s summation signal generation unit SB and forwarded to a bus driver BT. A bus signal PWDC is forwarded to the decoder unit DE of the second network unit NP via the first connection REFBUS.

This circuit arrangement as shown in FIG. 3 provides the advantage that the opportunity exists here for creating all pre-selected reference clock signals RCLK1, . . . , n from a single clock recovery unit CR or individual reference clock signals from the different bus signal provision units CH1, . . . , CHn and transmitting them to the second network unit NP. Data signals DSEn with suitable clock quality can be selected through configuration by the network operator.

A reference clock signal RCLKn is selected in the second network unit NP for a synchronization according to a priority list which can be defined in the network unit system controller NPSS of the second network unit NP. In the event of a fault, the decoder unit DS is used to help effect a delay-free switchover to another, possibly also higher-priority clock quality without involving the circuit units in the first network unit NTDM in connection with the network unit system controller NPSS of second network unit NP. The network unit system controller NPSS in the second network unit NP is notified immediately by the decoder DE about faults, such as for example a failure of the reference clock signal RCLK1, . . . , RCLKn. The failed reference clock source RCLK1, . . . , RCLKn is assigned in the network unit system controller NPSS on the basis of the stored configuration data.

The advantage of this circuit and the associated method in accordance with FIG. 3 lies in the fact that the firmware module in the first network unit NTDN and also a synchronization of the selection processes in the interface units is dispensed with. A further advantage lies in the fact that the further reference clock signals RCLKn can be selected at a later time without reconfiguring the first network unit NTDM and interrupting the bus operation between the network elements. This brings with it an increase in flexibility for the network operator so that changes in his network environment or expansion measures for his networks can be undertaken at any time.

The formation of the bus signal in the bus signal provision unit CHn is described below.

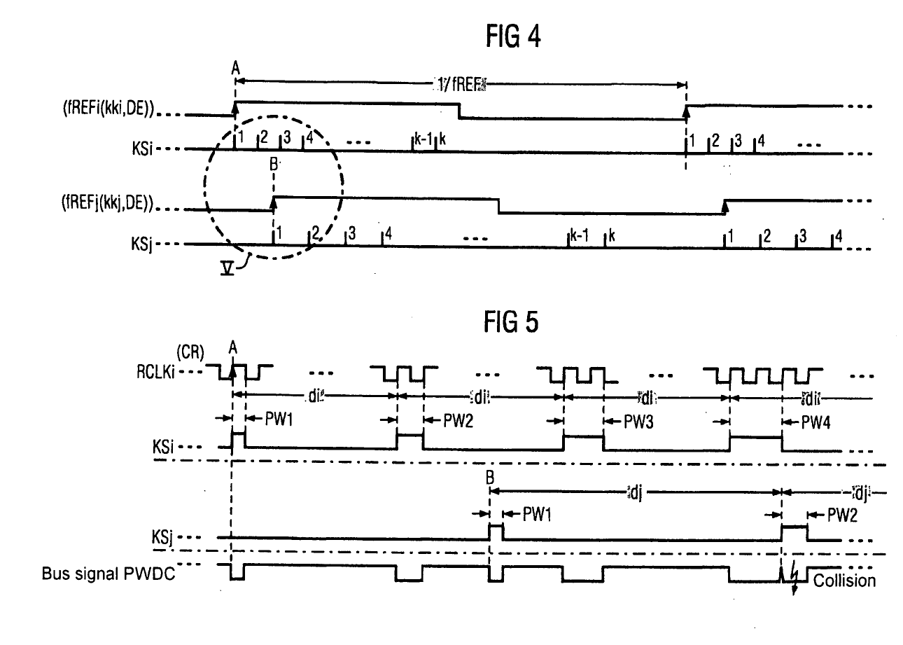

The formation of the bus signal PWDC is explained in greater detail below with reference to the diagrams in FIG. 4 and 5. The individual channels signals KSi, KSj are generated directly from the recovered reference clock signals RCLK by a frequency reduction and encoding, in that for each channel in each case with the periodicity of the defined reference frequency f(REF) a number of pulses corresponding to the total number of channels is created and for each channel the pulses are allocated fixed pulse distances di, dj. The pulse distances can be equidistant distances or freely selected distances. The pulse distances are also referred to as distance parameters. In accordance with the diagram in FIG. 5 the equidistant pulse distances of the individual channels KSi, KSj are embodied differently.

Within the individual channels different pulse widths are formed to identify the phase distance to the reference source (rising edge of the reference frequency f(REFx)). The pulse widths can for example be embodied with a linear gradation. It is advantageous for the pulse widths of the pulses to be embodied in ascending order for the pulse sequences. A unique assignment of the channels KS1, . . . , KSn in the bus signal PWDC is given by the defined pulse distances and pulse widths.

The pulse width of the pulse PW₁, . . . , PWₖ is based on a quantizing of the bus signal PWDC. The quantizing of the bus signal PWDC is defined by the pulse width of the RCLK reference clock signals. A phase relationship of the relevant reference frequency f(REFx) through the leading edge of the first pulse of the channel signal KSx (reference source) enables a channel selection in the decoder DE of the second network unit NP.

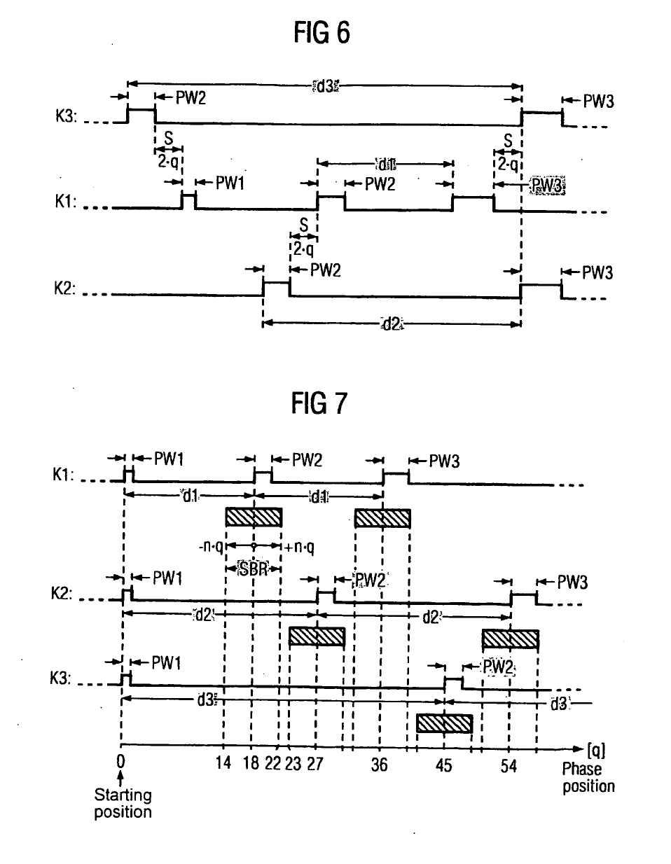

The pulses of the channel signals KS1, . . . , KSn are logically ORed with each other in the bus signal PWDC in negative logic (low-active), see FIG. 5. The distance parameters within the individual channels are dimensioned so that between the pulses there is still a sufficient safety margin S, as shown in FIG. 6, between the individual pulses.

As a result a frequency offset caused by jitter or wander or plesiosynchronicity between the independent clock sources RCLK1, . . . , RCLKn there is a slight phase shift of the pulses of the channel signals KS1, . . . , KSn originating from different channels. Specifying the distance parameters di, . . . , dj enables at least one pulse from the channel signal KS1, . . . , KSn of each channel to be transmitted without a collision and allows it to be used for synchronization of the central PLL in the clock generation unit T of the second network unit. Each individual pulse in the channel signal KS1, . . . , KSn has a defined phase relationship to its reference source through its predefined pulse width PW1, . . . , PWn. The PLL in the clock generation unit T can thus operate synchronously without adverse effects despite a collision-related change of the phase position of the selected pulse sequence. In the case of a collision in the selected impulse sequence the PLL can access a plurality of the redundant pulses in the channel signal with the aid of the control logic DS in the decoder DE and on the basis of the defined pulse width can execute a phase correction corresponding to the channel-specific distance parameters, in order to undertake a seamless transition.

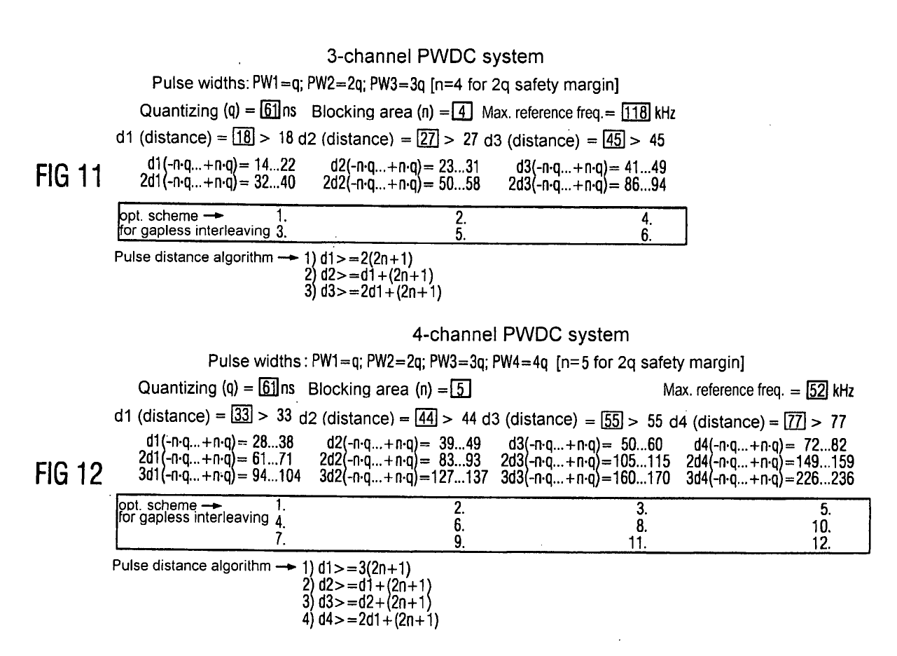

With reference to a tabular listing, as presented in FIGS. 11 and 12 as well as in the pulse diagrams of FIGS. 6 and 7, a definition of the pulse distances di, . . . , dj for the bus signal PWDC with a 3- and 4-channel system is specified. The resulting figures relating to the phase position in FIG. 11 are explained in FIG. 7. The channel signals KS1, KS2, KS3 are also referred to below as channels K1, K2, K3.

Arranged in a starting position (phase 0) is the rising edge of the first pulse with the pulse width PW1 in the channels K1, K2, K3. The phase position is specified in the phase units corresponding to the quantizing q of the reference clock signal RCLK. In the example q=61 ns and corresponds to a half period length of the 8192 Khz reference clock signal RCLK. The pulse widths PW1=q, PW2=2q, PW3=3q are embodied in accordance with a linear classification.

A blocking area SBR ensures a sufficient safety margin between the individual pulses below the channel signals with the aim of detecting a collision with the pulse sequence selected from the clock generation unit in good time and initiating a switchover with the aid of the control logic to an undisturbed pulse sequence in a new phase position in the channel.

The distance parameters d1, d2, d3 as also shown in FIG. 6, which can also be referred to as pulse distances of distance parameters are selected with regard to maintaining a possible reference clock signal, in that the blocking areas SBR of all channels involved are also taken into account. The controlling thus created for a scheme for concatenating pulses with blocking areas SBR can be defmed by the subsequent algorithm (see FIG. 11, 12):

Bus signal with 3 channels Bus signal with 4 channels

| Bus signal with 3 channels | Bus signal with 4 channels |
|---|---|
| max. pulse width PW3 = 3 · q | pulse width PW4 = 4 · q |
| d1 = 2 · (2n + 1) | d1 = 3 · (2n + 1) |
| d2 = 3 · (2n + 1) | d2 = 4 · (2n + 1) |
| d3 = 5 · (2n + 1) | d3 = 5 · (2n + 1) |
| | d4 = 7 · (2n + 1) |

In these formulae n is a factor for the blocking area SBR, which ensures a sufficient safety margin between the pulses of the bus signal PWDC. The factor n has the phase unit q. The value of n is varied as a function of the number of channels and the associated maximum pulse width, in order to obtain a sufficient safety margin S, as shown in FIG. 6.

For secure processing in the decoder DE with only double the clock rate, the safety margin corresponding to the pulse diagram should amount to at least S=2*q. With this procedure the decoder DE can work directly with the clock frequency of the PLL quartz oscillator in the clock generation unit T of 32,768 MHz. With the above algorithm this requires a blocking area SBR of n=4*q for a 3-channel system or n=5*q for a 4-channel system A prerequisite is a sufficient bandwidth for a distortion-free pulse transmission of the bus signal PWDC for the selected quantizing q of the reference clock signal.

The algorithm is illustrated below in a pulse diagram with reference to the 3-channel system in FIG. 7. To simplify an optimization only the maximum pulse width PW3 is considered, with greater safety margins than necessary thus being produced for pulses with smaller pulse widths. Taken as a reference position for this is the initial phase position of the first pulse of the channels K1, K2, K3 and the leading pulse edge in each case (phase 0). The blocking area SBR±n*q is related to the rising edge of the subsequent pulses. According to the algorithm the distance parameter d1 in the first channel of the 3-channel system amounts to d1=18*q, so that the first blocking area SBR of the first channel K1 begins on the phase position axis at 14*q and ends at 22*q. Immediately after this the blocking area SBR of the second pulse PW2 of the second channel K2 begins at 23*q, so that there is no gap between the blocking areas. Only before the last blocking area around the rising edge of the third pulse PW3 in the third channel K3, because of the equidistant pulse distance definition, is there a gap of 28*q (no longer shown in FIG. 7).

In accordance with the formula [q*(3*d3+n)]−1 the maximum achievable reference frequency f(REF) in the 3-channel system amounts to 118 KHz, assuming a quantizing of q=61 ns (see FIG. 11). For application of binary division relationships (2n) this produces a limitation of the reference frequency f(REF) to be transferred into the bus signal to 64 kHz. Under the same conditions this value reduces in the 4-channel system to 32 kHz, see FIG. 12. With a greater number of channels the equidistant pulse distance definition can be abandoned to counter too great a limitation of the achievable reference frequency.

An exemplary embodiment for encoding and decoding of the bus signal PWDC is shown in FIGS. 3 and 8 as well as in the pulse diagrams 9, 10 belonging to FIG. 8.

The channel signals KS1, KS2, . . . , KSn are generated in the encoding part KK of the bus provision unit CH1, . . . CHn with the aid of binary synchronous counters which are clocked directly from the reference signals RCLK. In accordance with the diagram shown in FIG. 3 the distance and pulse width parameters are defmed separately for each channel through configuration data and created with combinational networks. The clock recovery unit CR only enables and forwards to the encoder KK the intended reference clock signals RCLKn. If there is a loss of quality, enabled reference clock signals RCLKn are deactivated in good time by the clock recovery unit CR as a result of an alarm module integrated into this unit. After the channel signals KS1, . . . , KSn have been merged, the sum signal is routed via tristate bus drivers and transmitted to the REFBUS as a bus signal PWDC.

The mode of operation of a decoder DE in the second network unit NP is explained with reference to the basic circuit diagram in FIG. 8. The decoder DE is subdivided into other units, including functional blocks KSY, KSK and MST. These functional blocks are a channel synchronizer KSY, a channel selector KSK and a mask controller MST. All functional blocks are connected to the control unit DS. Three independently-operating channel separators KSP1, . . . , KSPn are arranged in the channel synchronizer KSY, corresponding to the number of channels. The channel signals are filtered out from the bus signal with the aid of a digital regulation circuit in a channel separator KSP in the channel synchronizer KSY function block. To this end the pulse width filters PWF or channel-specific pulse-distance filters PDF are employed for the correct selection and for the maintenance of the synchronism in the channel synchronizer. All these functions are executed as mask functions, so that a real-time transmission of the reference signals up to the clock generation unit T in an unrestricted bandwidth in the decoder is made possible.

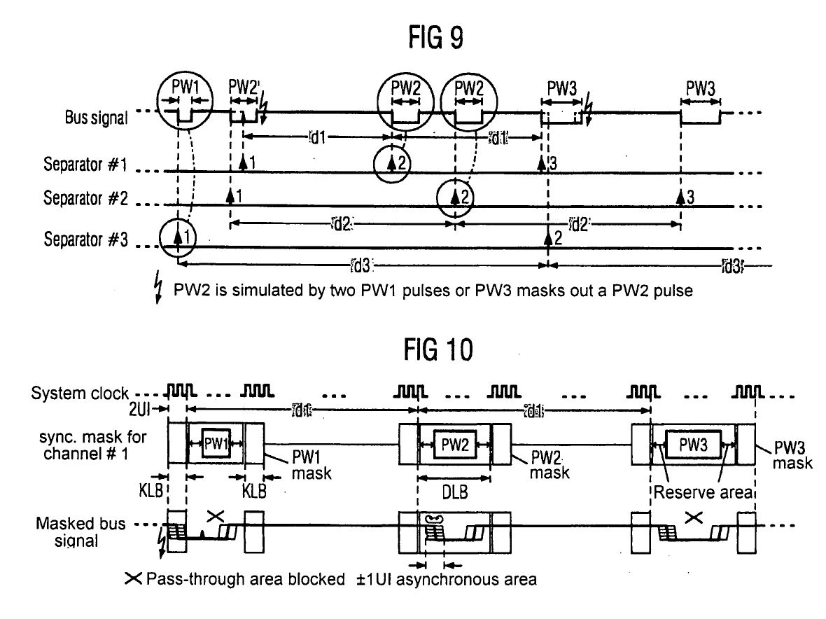

The first line of the pulse diagram in FIG. 9 shows the signal sequence transmitted on the bus. The output signals of the channel separators are reproduced in the subsequent pulse diagrams. Since the channel signals are not exactly synchronous with each other, the synchronization requires three independent control circuits for the three channels.

A switchover between the simultaneously available reference clocks available in the channel synchronizer KSY is undertaken on the basis of a list of priorities in the channel selector module KSK stored in the control unit DS. This allows a fast HW-controlled reaction to the problem.

The pulse sequence PW1, PW2, PW3 of a channel signal Kn selected in the channel selector module KSY is given a synchronously maintained mask in the mask control block MS, with for each reference clock period f(REF) only one collision-free pulse is forwarded to the PLL. In accordance with diagram shown in FIG. 10 this mask is adapted to the pulse width classification of the channel signal, with the mask being subdivided into at least two areas, the pass-through area DLB and the control area KLB. The pass-through area DLB is enabled prioritized in accordance with pulse width classification, if a number of collision-free pulses were found in the channel signal. The narrowest pulse is assigned the highest priority since it contributes directly to the phase position of the reference source.

The control area KLB is the outer part of the mask and is responsible for a collision prediction. If a foreign pulse from any given side comes into the control area KLB the pass-through area DLB of the mask involved is then blocked and simultaneously the next collision-free mask is enabled. The control area KLB is 2UI wide, with the abbreviation UI standing here for a Unit Interval and relating to the system clock period of the decoder. By comparison with the quantization stage used in the encoder, because of the doubled clock rate used, q stands here for a UI=0.5*q (31 ins), this corresponds to a system clock of 32,768 MHz.

The safety margin SBR of SBR=2*q parameterized in the algorithm is thus made up of a reserve area of 1*q(=2UI) for the pass-through area DLB, as well as of a further 1*q(=2UI) for the control area KLB of the mask. The digital regulation in the channel synchronizer operates with an internal quantizing of one UI, so that in the pass-through area in addition to quantization jitter, one UI remains reserved for the residual jitter on the channel signal. The quantizing of the pulse width measurement or the collision detection for the control area can on the other hand, with the use of the double sampling rate of 0.5 UI, be undertaken using both switching edges of the system clock, which increases the security and the dynamics of the regulation.

The blocking and enabling of the masks in different phase positions within a selected reference clock path is undertaken with the aid of a phase adaptation circuit. In units of the known channel-specific distance parameter a phase adaptation is performed here at each mask change. In this way pulses selected for synchronization always arrive in the same phase position as seen by the PLL.

For PLL modules of which the phase detector, e.g. an EXOR circuit, does not operate with edge control, the pulse width is also regenerated here after masking, by a sampling ratio of 1:1 being set digitally.

With digitally regulated mask control the pulses of the reference signals are forwarded without intermediate processing, meaning in real time to the PLL. The masks merely serve to filter out the redundant pulses within a channel.

All functions of the mask control can be executed in hardware in order to achieve optimum dynamics for the regulation. Individual functions of the mask control can also be relocated by corresponding software into the firmware module FWM of the packet hub PHUB. The possible longer reaction time arising as a result can be bridged by possible provision of a holdover function in the Phase-Locked Loop circuit PLL.

The channel selector module KSK can also be integrated into the module for mask control MST by corresponding enabling of the pass-through masks. Furthermore the formation of the mask area, control and pas-through area can be linked directly to the digital regulation circuit of the channel synchronizer. The phase adaptation circuit can be implemented in the PLL feedback loop in a common hardware embodiment.

1-22. (canceled)

23. A circuit for clock synchronization between a first and a second network unit, comprising:
a clock recovery unit having at least one reference clock signal provided in the first network unit;
a bus provision unit with an encoding unit arranged in the first network unit where the encoding unit is used for creating a channel signal from the reference clock signal; and
a bus signal created from a plurality of channel signals and forwarded to a decoder unit in the second network unit.

24. The circuit as claimed in claim 23, wherein the encoding unit is configured such that a sequence of individual pulses with a defmed distance is created from the reference clock signal present on the input side.

25. The circuit as claimed in claim 24, wherein the encoding unit is configured such that the defined distances of the pulses are different for each channel signal.

26. The circuit as claimed in claim 25, wherein the encoding unit is configured such that the number of pulses created in each channel signal corresponds to the maximum possible number(s) of the encoding units.

27. The circuit as claimed in claim 26, wherein the encoding unit is configured so:
the width of the created pulses are different,
the width of the pulses created are embodied in ascending order, and
no distinction is made with regard to pulse width formation below the encoding units.

28. The circuit as claimed in claim 27, wherein the bus provision unit is configured so the channel signals are grouped together via a summation unit and signal amplification unit into a bus signal.

29. The circuit as claimed in claim 23, wherein the decoding unit has a pulse width filter and a pulse distance filter.

30. The circuit as claimed in claim 29, wherein the decoding unit is configured so that decoding is performed by a mask function, where the received bus signal is not sampled and the selection occurs by masking out the non required pulses.

31. The circuit as claimed in claim 30, wherein the created pulses having different pulse width and pulse distance are coordinated for simultaneous collision free real-time transmission of the clock signals.

32. The circuit as claimed in claim 31, wherein the selection of an individual channel signal from the bus signal is performed independently by the second network unit.

33. A method for clock synchronization between a first and second network unit, comprising:
providing a reference clock signal in the first network unit by a clock recovery unit;
forming a channel signal from a reference clock signal where in the first network unit a bus signal being formed from at least one channel signal and forwarded to the second network unit;
creating pulses having different pulse width and pulse distance; and
coordinating the pulse distance and pulse width encoding for simultaneous collision free real-time transmission of the clock signals.

34. The method as claimed in 33, wherein a sequence of individual pulses with a defined distance is created from the reference clock signal present on the input side.

35. The method as claimed in 34, wherein the defined distances of the pulses are characterized differently in each channel signal and the number of pulses generated in each channel signal corresponds to a maximum possible number of the encoding units.

36. The method as claimed in claim 35, wherein the created pulses are created in ascending order relative to their pulse width.

37. The method as claimed in claim 36, wherein pulse width formation is not considered below the encoding units.

38. The method as claimed in claim 37, wherein the channel signals are grouped into a bus signal.

39. The method as claimed in claim 38, wherein the individual channel signals are selected from the bus signal independently by the second network unit.

40. The method as claimed in 39, wherein decoding is performed in the second network unit by a mask function, where the received bus signal is not sampled and the selection is made by masking out the un-required pulses.

41. A circuit for clock synchronization between a first and a second network unit, comprising:
a clock recovery unit having at least one reference clock signal provided in the first network unit;
a bus provision unit with an encoding unit arranged in the first network unit where the encoding unit is used for creating a channel signal from the reference clock signal; where created pulses having different pulse width and pulse distance are coordinated for simultaneous collision free real-time transmission of the clock signals; and
a bus signal created a plurality of channel signals and forwarded to a decoder unit in the second network unit where the selection of an individual channel signal from the bus signal is performed independently by the second network unit.
